(19) United States
(12) Patent Application Publication
(10) Pub. No.: US 2004/0223825 A1
(43) Pub. Date: Nov. 11, 2004

(54) Broach tool and broaching method

(75) Inventors: Soichi Kakutani, Toyama (JP); Yasuhiro Murai, Toyama (JP)

Correspondence Address: VENABLE, BAETJER, HOWARD AND CIVILETTI, LLP, P.O. BOX 34385, WASHINGTON, DC, 20043-9998, US

(73) Assignee: NACHI-FUJIKOSHI CORP., Toyama-ken (JP)

(21) Appl. No.: 10/832,302

(22) Filed: Apr. 27, 2004

(30) Foreign Application Priority Data
May 7, 2003 (JP) 2003-128625

(51) Int. Cl. B23D 37/00

(52) U.S. Cl. 409/244

(57) ABSTRACT

A broach tool for finishing a hollow hole has a number of cutting edges arranged in order of dimensions in a longitudinal direction. The cutting edges in at least a finishing portion are formed of cemented carbide. A cutting depth of each edge in a cutting direction is 5 μm to 15 μm for slots such as a spline hole and a ball groove, or 3 μm to less than 9 μm for a round broach hole. A work has the hollow hole pre-worked leaving a finish cutting allowance, and has hardness of 45 to 65 HRC (Rockwell hardness C scale) after subjected to a thermal treatment. A hollow hole cut surface is finished into the finished dimension with use of the broach tool. The broach tool has little chipping on cutting edge tips and is hardly abnormally worn and has a long life.

### BACKGROUND OF THE INVENTION

The present invention relates to a broaching tool or broach and a broaching method, and particularly, to a tool and a method for use in broaching for finishing a hollow hole in a material of high hardness corresponding to 45 to 65 HRC (Rockwell hardness C scale).

A broach for finishing a highly hard material of hardness corresponding to 45 to 65 HRC after a thermal treatment, is disclosed, for example, in JP-A-2001-239425. In this broach, tool material forming finish cutting edges is cemented carbide, each cutting edge is further coated with a hard coating, and a rake angle of each cutting edge is set at −10 to −30°. The broach thus constructed is intended to provide a satisfactory worked surface in cutting the high-hardness material. Moreover, the broach is intended for use in working at a speed of 40 to 60 m/min to reduce a tool wear amount.

JP-A-2001-239425 mentioned above has no reference to a finishing allowance of each cutting edge of the broach and to a cutting depth per cutting edge of the broach (an amount for which the cutting edge cuts into a work).

Hitherto, in a broach tool for use in working before thermal treatment, a cutting depth per cutting edge of the broach has usually been set at about 25 μm to 30 μm for a spline hole, or about 9 μm to 20 μm for a round broach hole with respect to a carbon or alloy steel work. If the cutting depth is set to be less than 20 μm for slots such as the spline hole and a ball groove, or to be less than 9 μm for a round broach hole, the cutting edges are worn by rubbing between the cutting edges and the work, and a tool life is shortened.

Moreover, there has not heretofore been an established theory of the cutting depth regarding broaching for finishing a high-hardness material of hardness between 45 and 65 HRC after a thermal treatment. Contrarily, when the cutting depth per edge is reduced, a problem occurs that a broach length is increased to raise a tool cost.

### SUMMARY OF THE INVENTION

The present invention has an object of solving the above-described conventional problems and of providing a long-life broach tool which is used in broaching for finishing a hollow hole of a high-hardness material having hardness corresponding to 45 to 65 HRC after a thermal treatment and which has little chipping on a blade tip or little abnormal wear.

Another object of the invention is to provide a method of performing satisfactory broaching with use of the above broach tool.

A broach tool for finishing of a hollow hole according to the invention, which has a number of cutting edges arranged in a longitudinal direction in order of dimensions, is characterized in that in at least a finishing portion the cutting edges are formed of cemented carbide, and a cutting depth of each cutting edge in a cutting direction is 5 μm to 15 μm for slots such as a spline hole and a ball groove, or 3 μm to less than 9 μm for a round broach hole.

With the above construction, the cutting depth of each cutting edge of at least the finishing portion is reduced to limit the stress imposed on a cutting edge tip at a certain level, and the tip can be prevented from being chipped. Since the cutting edge is formed of cemented carbide, thermal resistance and resistance to wear are enhanced, and the tool becomes more durable against wear.

It is preferable for the cemented carbide that an average particle size of WC is 0.4 to 0.8 μm, and a Co content is 5 to 15 wt %. This provides the cutting edge with superior resistance to wear even in a condition that the cutting depth is small and there is much rubbing.

A broaching method for finishing a hollow hole according to another aspect of the invention comprises preparing a work having the hollow hole pre-worked with a finish cutting allowance being left and having hardness of 45 to 65 HRC (Rockwell hardness C scale) after a thermal treatment, and finishing a cut surface of the hollow hole to a finished dimension with use of the above-described broach tool. According to this working, a friction coefficient between the high-hardness work and the broach tool is lowered, heat generation is decreased, wear is reduced, and the tool life can be lengthened.

The finish cutting allowance is preferably from 0.01 mm to 0.15 mm in the cutting direction of the finishing with respect to the finished dimension.

According to the above-described constitution of the invention, there are provided the broach tool which is used in broaching for finishing a hollow hole in a high-hardness material of hardness corresponding to about 45 to 65 HRC, and which has less chipping on its cutting edge tips, less abnormal wear and a long life even when the cutting edges are formed of cemented carbide, and the method for allowing satisfactory broaching.

Other objects, features and advantages of the invention will become apparent from the following description of an embodiment of the invention taken in conjunction with accompanying drawings.

### BRIEF DESCRIPTION OF THE DRAWING

FIG. 1 is an elevation side view of a broach tool for use in finishing a hollow hole of a work after a thermal treatment according to an embodiment of the present invention;

FIG. 2 is a plan view of the work having a spline hole which is one example of an object to be worked by the broach tool of FIG. 1;

FIG. 3 is an enlarged explanatory view of a worked groove portion of the spline hole of FIG. 2; and

FIG. 4 is an explanatory graph showing large diameters of the spline hole, which is the object to be worked of FIG. 2, after broaching before the thermal treatment, after the thermal treatment, and after finish broaching.

### DESCRIPTION OF THE PREFERRED EMBODIMENT

Hitherto, in a broach tool for use in working before thermal treatment, it has been ordinary to set a cutting depth per cutting edge of the broach at 25 μm to 30 μm for slots such as a spline hole and a ball groove or at about 9 μm to 20 μm for a round broach hole with respect to works of carbon steel and alloy steel. This is because that if the cutting depth is less than 20 μm for the slots such as the spline hole and ball groove or less than 9 μm for the round broach hole, the cutting edges are worn by rubbing between them and the work, and a tool life is shortened.

When a high-hardness material to be cut of hardness corresponding to 45 to 65 HRC after thermal treatment is worked with the broach having the same cutting depth, tips of the cutting edges are chipped, and the tool life is shortened. This is because that as the material to be cut is hard, and as the cutting edges for working this material are much harder, the tips are easily chipped and have a brittle property.

The present inventors have thought that when the high-hardness material to be cut having hardness corresponding to 45 to 65 HRC after the thermal treatment is worked, it is important for lengthening of the tool life to first reduce the chipping rather than the rubbing of the cutting edges. Therefore, in the present invention, the cutting depth per cutting edge of the broach tool in a cutting direction is limited to 5 μm to 15 μm for the slots such as the spline hole and ball groove, or 3 μm to less than 9 μm for the round broach hole. With this, a stress acting on the cutting edge tips is suppressed at a constant level, and the tips can be prevented from being chipped. Further, as the material of the cutting edges is cemented carbide, resistances to heat and wear are strength, and the tool is durable also against wear.

When the cutting depth of one edge in the cutting direction is less than 5 μm for the slots such as the spline hole and ball groove, and less than 3 μm for the round broach hole, the cutting edges are worn through rubbing between the cutting edges and the work, and the tool life is shortened. Moreover, when the cutting depth is reduced, a total length of the broach is increased, and a broach cost is raised. The present invention prevents this problem.

On the other hand, when the cutting depth of one edge in the cutting direction exceeds 5 μm for the slots such as the spline hole and ball groove, and 9 μm or more for the round broach hole, the cutting edge tips begin being chipped. Further, when the cutting depth is reduced, the broach total length is increased, and the broach cost is raised. In the present invention, for preventing this problem, in finishing of the hollow hole, it is assumed that the material is pre-worked leaving a finish cutting allowance from 0.01 mm to 0.15 mm in the cutting direction of finishing with respect to a finished dimension.

The reason why the finish cutting allowance is set to be 0.01 mm or more is the following aimed at by the inventors. In the working of the inner surface of a hollow component, a hole diameter is often reduced due to deformation by thermal treatment. Therefore, even when a pre-working dimension is set equal to a final finished dimension, even considering working unevenness in the surface configuration formed by the pre-working, the cutting allowance is not eliminated. Inner-surface broaching is balance cutting and has a characteristic of following the pre-worked surface configuration. Therefore, even when the cutting allowance is small, the impartial cutting deviation hardly occurs, a black scale is hardly left, and it is possible to set a very small cutting allowance such as about 0.01 mm.

Moreover, the reason why the allowance is set to be 0.15 mm or less is that there are many cases where depending on a shape of the work, the thermal treatment deformation is distorted, a hole diameter is locally enlarged, and a margin needs to be given to a machining allowance to an extent that the broach tool is not resultantly lengthened and does not become uneconomical. This upper limit is preferably set to be as small as possible through observation of a state of the thermal treatment deformation of the objective work.

It is preferable for cemented carbide used in the tool of the invention that an average particle diameter of WC is 0.4 to 0.8 μm and a Co content is 5 to 15 wt %. This is because the cutting edge is not easily manufactured when the average particle diameter of WC is less than 0.4 μm. When the diameter exceeds 0.8 μm, the edge is easily chipped. Similarly, when the Co content is less than 5 wt %, the edge is easily chipped, and when the content exceeds 15 wt %, the resistance to wear is deteriorated.

Incidentally, by applying a hard coating of TiAlN on the cutting edge surface other than a rake surface of each cutting edge, the tool becomes more strong against wear and has a longer life.

FIG. 2 shows an example of a work which is an object to be worked by the broach according to the embodiment of the invention. The objects to be worked in this work 6 are four spline large-diameter grooves 7 to 10 of square splines formed in a work inner diameter.

A large diameter at the time of completion of each spline was set at φd1=40.0 mm, and the large-diameter spline was worked at φd2=39.9 mm with a broach for pre-working. That is, the work was pre-worked leaving a finishing allowance of 0.1 mm in terms of the diameter with respect to a finished dimension. The work 6 was then carburized and hardened, and the surface hardness was set at 60 HRC. The carburizing depth was about 1 mm. At this time, the work was reduced in its inner diameter due to thermal treatment deformation, and the spline large-diameter after the thermal treatment was φd3=39.8 to 39.85 mm (minimum value of φd3: φd3 min=39.8 mm). A relation among d1, d2, d3 is shown in FIG. 4.

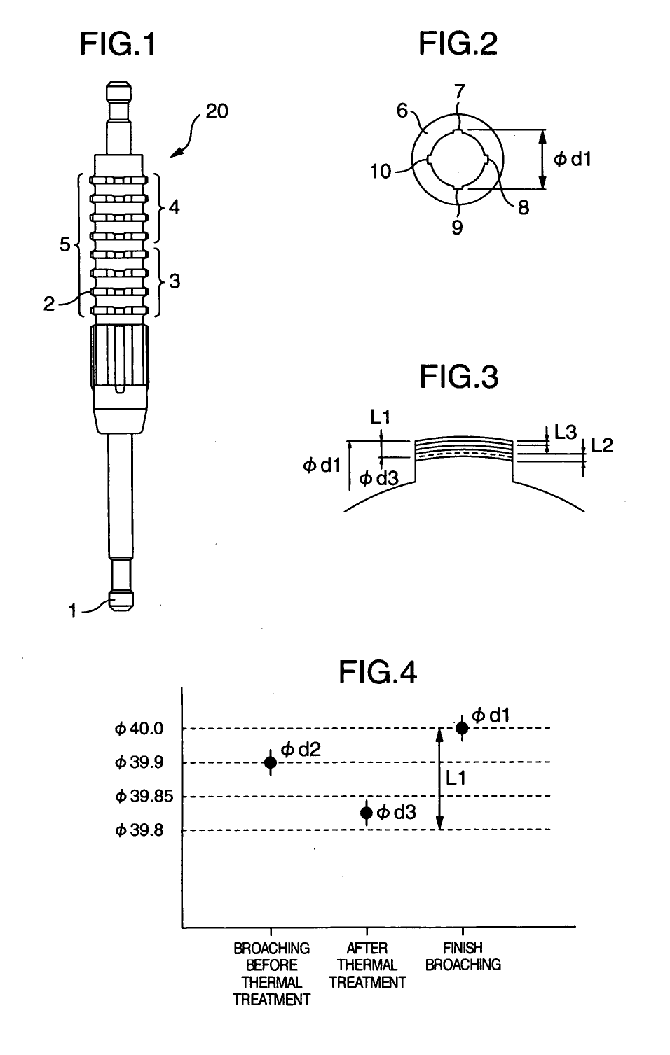

FIG. 1 shows the broach tool 20 according to the embodiment of the invention, which is for finishing the spline large-diameter portions shown in FIG. 2. It is to be noted that although the object to be worked is the square splines in this example, it may also be slots such as a ball groove instead. When a round broach hole is to be finished, a broach tool for a round hole, having a shape similar to that of the hole, is used.

The broach tool of FIG. 1 is a broach tool for finishing a hollow hole, in which a number of cutting edges 2 are arranged in order of dimensions in an axial direction or longitudinal direction of a cutting edge portion 5. The cutting edges 2 of at least a finishing portion 4 are formed of cemented carbide, and a cutting depth of each cutting edge in a cutting direction is set at 5 μm to 15 μm. The cutting depth is set at 3 μm to less than 9 μm for the round broach hole.

The broach tool 20 of FIG. 1 includes a number of cutting edges 2 following a grip portion 1. The cutting edges 2 are formed of cemented carbide in which an average particle diameter of WC is 0.7 μm and a Co content is 11 wt %. A cutting edge surface other than a rake surface of each cutting edge 2 is coated with a hard coating of TiAlN. In a former half 3 of the cutting edge portion 5, a cutting depth per cutting edge was set at 15 μm. In the finishing portion 4 or a latter half for finishing of the cutting edge portion 5, the cutting depth per cutting edge was set at 10 μm.

In cutting by this broach, as shown in FIG. 3, a total cutting depth is L1=(d1−d3min)/2=0.1 mm. The cutting depth of the former half 3 of the cutting edge portion 5 was set at L2=15 μm, the cutting depth of the latter half 4 was set at L3=10 μm, the number of cutting edges in the former half 3 of the cutting edge portion 5 was set at four, and the number of cutting edges of the latter half 4 was set at four. Further, since a pitch of broach edges of the cutting edge portion 5 was set at 15 mm, and since a total length of the broach cutting edge portion was set at about 120 mm, the broach was compact and economical.

The spline large-diameter portion of the work after the thermal treatment shown in FIG. 2 was worked with the broach thus formed. As a result, chipping of the cutting edge tips was largely reduced and the tool life was two or more times as compared with a case where the cutting depth was set at 25 μm.

In the embodiment of the invention, the hollow hole of the high-hardness material after thermal treatment was finished with the broach whose cutting depth of one cutting edge in the cutting direction was 5 μm to 15 μm for the slots such as the spline hole and ball groove, and 3 μm to less than 9 μm for the round broach hole. Therefore, there is little chipping or abnormal wear on the cutting edge tips, and long-life broaching is possible. Especially, even when the cutting edge material is cemented carbide, the tool has a long life without being chipped.

Moreover, in the pre-working, the finish cutting allowance is set at 0.01 mm to 0.15 mm in the cutting direction of finishing with respect to a finished dimension. Therefore, any non-worked black scale is not left. Even with the carbide broach having the cutting depth per edge of 15 μm or less, the total length of the broach is small, and the broach is superior in economical efficiency. Furthermore, since the cutting edge surface other than the rake surface of each cutting edge 2 is coated with TiAlN, there is provided the tool which is more resistant to wear and has a longer life.

Furthermore, the cutting edge is formed of cemented carbide having a WC average particle diameter of from 0.4 to 0.8 μm and a Co content of from 5 to 15 wt %, the tool is superior in the resistance to wear even in a condition that the cutting depth is small and there is much rubbing.

The invention is characterized in that the cutting depth per edge of the broach tool in the cutting direction is set at 5 μm to 15 μm for the slots such as the spline hole and ball groove, and at 3 μm to less than 9 μm for the round broach hole. However, for example, in a case where the cutting depth is changed with cutting edges for coarse working and those for finishing, even when the cutting depth per cutting edge for finishing is set at 15 μm or less, a certain degree of effect is obtained. This is because that even if the life of the cutting edge for the coarse working is ended first, chipping of the finishing edges can be retarded.

The invention is not limited to the square spline working of the above-described embodiment, and is also similarly applicable to large-diameter working, tooth surface working or inner-diameter working of an involute spline, or a combination of them, or ball groove working or inner-diameter working of a CVT, or a combination of them.

It will be further understood by those skilled in the art that the foregoing description has been made on the embodiment of the invention and that various changes and modifications may be made in the invention without departing from the spirit of the invention and the scope of the appended claims.

What is claimed is:

1. A broach tool for finishing a hollow hole, comprising:
an elongated cutting edge portion;
a number of cutting edges arranged in order of dimensions in a longitudinal direction in the cutting edge portion; and
said cutting edges in at least a finishing part of the cutting edge portion being formed of cemented carbide with a cutting depth of each cutting edge in a cutting direction being from 5 μm to 15 μm for slots such as a spline hole and a ball groove or from 3 μm to less than 9 μm for a round broach hole.

2. The tool according to claim 1, wherein in the cemented carbide, an average particle diameter of WC is from in a range of 0.4 to 0.8 μm, and a Co content is from 5 wt % to 15 wt %.

3. The tool according to claim 1, wherein the broach tool is adapted to finish a hollow hole cut surface into a finished dimension, which has been pre-worked leaving a finishing allowance and has hardness corresponding to 45 to 65 HRC (Rockwell hardness C scale) after subjected to a thermal treatment.

4. The tool according to claim 3, wherein in the cemented carbide, an average particle diameter of WC is from in a range of 0.4 to 0.8 μm, and a Co content is from 5 wt % to 15 wt %.

5. A broaching method for finishing a hollow hole, comprising the steps of:
preparing a work having the hollow hole pre-worked with a finish cutting allowance being left and having hardness of 45 to 65 HRC (Rockwell hardness C scale) after to a thermal treatment; and
finishing a hollow hole cut surface into a finished dimension with use of the broach tool according to any one of claims 1 to 4.

6. The method according to claim 5, wherein the finish cutting allowance is from 0.01 mm to 0.15 mm in the cutting direction of the finishing with respect to the finished dimension.
